(19) United States
(12) Patent Application Publication
(10) Pub. No.: US 2025/0067580 A1
(43) Pub. Date: Feb. 27, 2025

(54) Attachment Arrangement and Corresponding Sensor Arrangement

(71) Applicant: Robert Bosch GmbH, Stuttgart (DE)

(72) Inventor: Werner Steinberger, Immenstadt (DE)

(21) Appl. No.: 18/726,278

(22) PCT Filed: Oct. 27, 2022
(86) PCT No.: PCT/EP2022/080094

§ 371 Date: Jul. 2, 2024

(30) Foreign Application Priority Data
Jan. 5, 2022 (DE) 10 2022 200 054.4

(51) Int. Cl. G01D 11/30; F16B 39/284

(52) U.S. Cl. CPC G01D 11/30; F16B 39/284; F16B 2200/506

(57) ABSTRACT

An attachment arrangement includes a plastic flange connected to a component to be attached and has a through-opening, and having an attachment screw, the threaded shank of which passes through the through-opening of the plastic flange and is screwed into a threaded hole at the installation location. An elastic constriction is formed in a region of the through opening facing the threaded hole, the inner spacing of which constriction is smaller than an outer diameter of the threaded shank of the attachment screw. The threaded shank plastically and elastically deforms the elastic material of the constriction during the screwing-in process, such that, when the attachment screw is screwed in, a frictional connection is formed between threads of the threaded shank and the remaining elastic material of the constriction, which frictional connection acts to prevent the attachment screw from loosening. A sensor arrangement having such an attachment arrangement is described.

The invention relates to an attachment arrangement and a corresponding sensor arrangement having such an attachment arrangement.

Wheel speed sensors and a plurality of other vehicle components are very often screwed on in the vehicle. Usually, a metallic bushing is injected or mounted into components that have a plastic flange. The objective is to represent a pretensioned screw connection that is completely metallic and prevents the screw connection from being loosened under load in the vehicle.

Locknuts are also known from the prior art, which have a plastic ring (usually polyamide) with a smaller inner diameter than the outer diameter of a corresponding screw Da. This plastic ring is plastically and elastically deformed when the screw is screwed in. This creates a frictional connection or a frictional locking which secures the screw connection to prevent loosening.

DE 26 38 937 C3 discloses a threaded connecting element, in particular a screw or nut connection, with a metal retaining ring with substantially radially extending ribs and a spring element provided between the retaining ring and the connecting element, the volume of which is smaller than the volume of the receiving chamber formed between the connecting element and the inner wall of the retaining ring and which is arranged free from the flow of an axial force, in particular the preload force. In this case, the connecting element, in particular the screw or nut, also has corresponding projections extending radially outside the wrench flat. The spring element is made of elastic plastic and only partially fills the receiving chamber formed between the ribs and the projections in the radial direction, but such that the plastic can penetrate both into the cavities between the ribs and into the cavities between the projections.

DE 86 09 005 U1 discloses an arrangement for securing screws. The arrangement comprises a securing element for non-round, in particular hexagonal screw heads, which are countersunk into a recess, the wall surface of which extends at a distance from the screw head. The locking element consists of a viscoplastic plastic and is designed as a ring-like body which surrounds the screw head and is pressed into the space between the screw head and the wall surface.

### DISCLOSURE OF THE INVENTION

The attachment arrangement with the features of independent patent claim 1 has the advantage that the additional metallic bushing described at the beginning can be dispensed with, and an attachment screw of the attachment arrangement can nevertheless not loosen automatically under the conditions of use in the vehicle and a residual preload of the screw connection is maintained. In addition, no special attachment screws are required for embodiments of the attachment arrangement according to the invention. This can result in a potentially higher level of customer acceptance.

Embodiments of the present invention provide an attachment arrangement having a plastic flange, which is connected to a component to be attached and has a through-opening, and an attachment screw, the threaded shank of which passes through the through-opening of the plastic flange and is screwed into a threaded hole at the installation location. An elastic constriction is formed in the through-opening, the inner spacing of which is smaller than an outer diameter of the threaded shank of the attachment screw. During the screwing-in process, the threaded shank deforms the elastic material of the constriction plastically and elastically, such that, when the attachment screw is screwed in, a frictional connection or frictional locking is formed between threads of the threaded shank and the remaining elastic material of the constriction, which acts to prevent the attachment screw from loosening.

In addition, a sensor arrangement with a sensor is proposed, which is attached to the installation location via such an attachment arrangement.

The component to be attached can be understood to be, for example, a vehicle component such as a sensor or the like. The installation location can be understood to mean, for example, a bracket, a body component or the like.

Advantageous improvements to the attachment arrangement specified in independent claim 1 and the sensor arrangement specified in independent claim 9 are possible by means of the measures and further embodiments listed in the dependent claims.

It is particularly advantageous that the elastic constriction can be formed in an end region of the through-opening facing the threaded hole. Due to the preferred position of the constriction in the lower region of the through-opening, the attachment screw can already be advantageously pre-centered during assembly.

In an advantageous embodiment of the attachment arrangement, the through-opening can be made as an elongated hole in the plastic flange. As a result, tolerances in the distance between the slot and the threaded hole can be better compensated for, for example, when mounting a sensor which is to be inserted into a slot and screwed into the threaded hole via the attachment screw. At the same time, the sensor can have improved guidance against twisting in the slot. In order to prevent the attachment screw from loosening, the constriction can, for example, comprise at least two constriction webs, which can be formed on opposite longitudinal sides of the elongated hole. Alternatively, the through-opening can be designed as a rotationally symmetrical opening in the plastic flange.

In a further advantageous embodiment of the attachment arrangement, the constriction can comprise a plurality of constriction segments, which can preferably be distributed evenly spaced apart from one another on the inner circumference of the through-opening. Alternatively, the constriction can comprise a constriction lip, which can be formed circumferentially on the inner circumference of the through-opening. Of course, other embodiments of the geometry of the constriction are also conceivable.

In a further advantageous embodiment of the attachment arrangement, the plastic flange with the through-opening and the constriction can be designed as a plastic injection-molding component. This means that the geometry of the constriction can be produced directly in the injection mold during the production of the attachment flange or the component to be attached without additional components and at no extra cost.

In an advantageous embodiment of the sensor arrangement, the sensor can comprise a housing with a first housing part and a second housing part, which can be inserted into a slot at the installation location. In this case, the plastic flange between the first housing part and the second housing part can be connected to the housing and screwed to the threaded hole at the installation location via an attachment screw. Preferably, the plastic flange with the constriction can be produced directly in the injection mold during the production of the housing of the sensor in a cost-neutral manner.

Exemplary embodiments of the invention are illustrated in the drawings and explained in more detail in the following description. In the drawings, identical reference signs refer to components or elements performing identical or similar functions.

### BRIEF DESCRIPTION OF THE DRAWINGS

FIG. 1 shows a schematic perspective view of an exemplary embodiment of a sensor arrangement according to the invention with an exemplary embodiment of an attachment arrangement according to the invention.

FIG. 2 shows a schematic perspective sectional view of the attachment arrangement according to the invention from FIG. 1.

FIG. 3 shows a sectional view of a plastic flange of the attachment arrangement according to the invention shown in FIGS. 1 and 2.

FIG. 4 shows a plan view of a first exemplary embodiment of the plastic flange from FIG. 3.

FIG. 5 shows a perspective view of a section of a second exemplary embodiment of the plastic flange from FIG. 3.

FIG. 6 shows a perspective view of a section of a third exemplary embodiment of the plastic flange from FIG. 3.

### EMBODIMENTS OF THE INVENTION

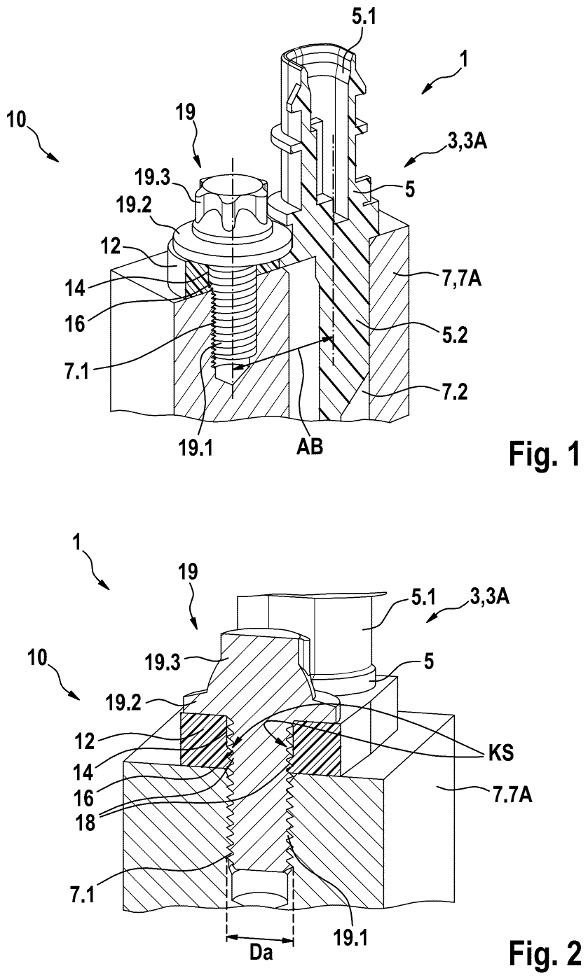

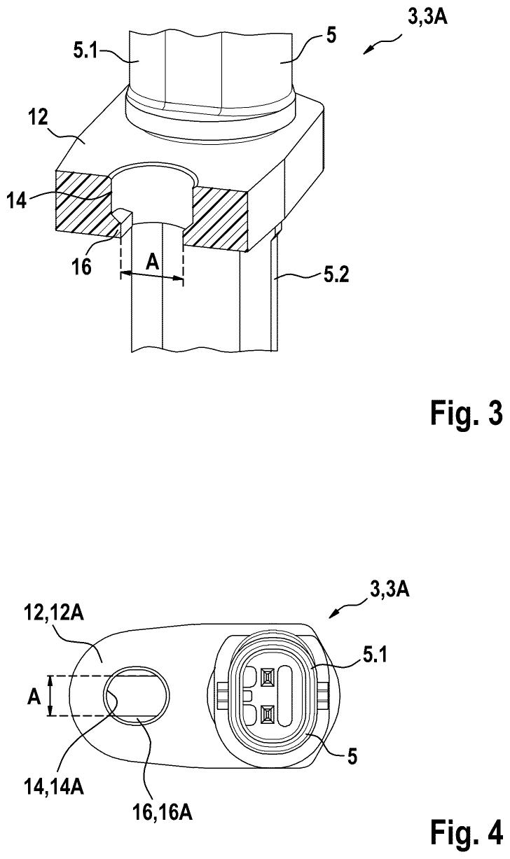

As FIGS. 1 to 3 show, the illustrated exemplary embodiment of an attachment arrangement 10 according to the invention comprises a plastic flange 12, which is connected to a component 3 to be attached and has a through-opening 14, and an attachment screw 19, the threaded shank 19.1 of which passes through the through-opening 14 of the plastic flange 12 and is screwed into a threaded hole 7.1 at the installation location 7. An elastic constriction 16 is formed in the through-opening 14, the inner spacing A of which is smaller than an outer diameter of the threaded shank 19.1 of the attachment screw 19. During the screwing-in process, the threaded shank 19.1 deforms the elastic material of the constriction 16 plastically and elastically, such that, when the attachment screw 19 is screwed in, a frictional connection KS or frictional locking is formed between threads of the threaded shank 19.1 and the remaining elastic material of the constriction 16, which acts to prevent the attachment screw 19 from loosening.

As can also be seen from FIGS. 1 to 6, the component 3 to be attached is a sensor 3A in the exemplary embodiments shown, which is designed here as a speed sensor. In the exemplary embodiment of the corresponding sensor arrangement 1 shown, the sensor 3A is attached to the installation location 7 via the attachment arrangement 10 according to the invention. As can also be seen from FIGS. 1 to 6, the sensor 3A comprises a housing 5 with a first housing part 5.1, which is designed here as a plug receptacle, and a second housing part 5.2, which is inserted into a slot 7.2 at the installation location 7. In the exemplary embodiments shown, the plastic flange 12 is connected to the housing 5 between the first housing part 5.1 and the second housing part 5.2 and is screwed to the threaded hole 7.1 at the installation location 7 via an attachment screw 19. Here, the housing 5 of the sensor 3A and the plastic flange 12 with the through-opening 14 and the constriction 16 are manufactured in a joint plastic injection molding process. In the exemplary embodiment shown, the installation location 7 corresponds to a bracket 7A, in which the threaded hole 7.1 and the mounting hole 7.2 are located at a predetermined distance AB from each other.

As can be further seen from FIGS. 1 to 3, the elastic constriction 16 is formed in an end region of the through-opening 14 facing the threaded hole 7.1. As a result, the attachment screw 19 is pre-centered when it is inserted into the through-opening 14 until the constriction is reached. As can also be seen in FIGS. 1 and 2, the attachment screw 19 has a screw head 19.2 with a support plate 19.3 in addition to the threaded shank 19.1. During assembly, the threaded shank is screwed through the constriction 16 into the threaded hole 7.1. As a result, the threaded shank 19.1 deforms the elastic material of the constriction 16 plastically and elastically, so that when the attachment screw 19 is screwed in as shown, with the support plate 19.3 of the screw head 19.2 resting on the plastic flange 12, interference 18 occurs between threads of the threaded shank 19.1 and the remaining elastic material of the constriction 16. The resulting frictional connection KS or frictional locking secures the attachment screw 19 against loosening.

Various embodiments of the plastic flange 12, 12A, 12B, 12C are described below with reference to FIGS. 4 to 6.

As can be further seen from FIG. 4, the through-opening 14 in the first exemplary embodiment of the plastic flange 12A shown is formed as an elongated hole 14A in the plastic flange 12A. Here, the constriction 16 comprises two constriction webs 16A, which are formed on opposite longitudinal sides of the elongated hole 14A.

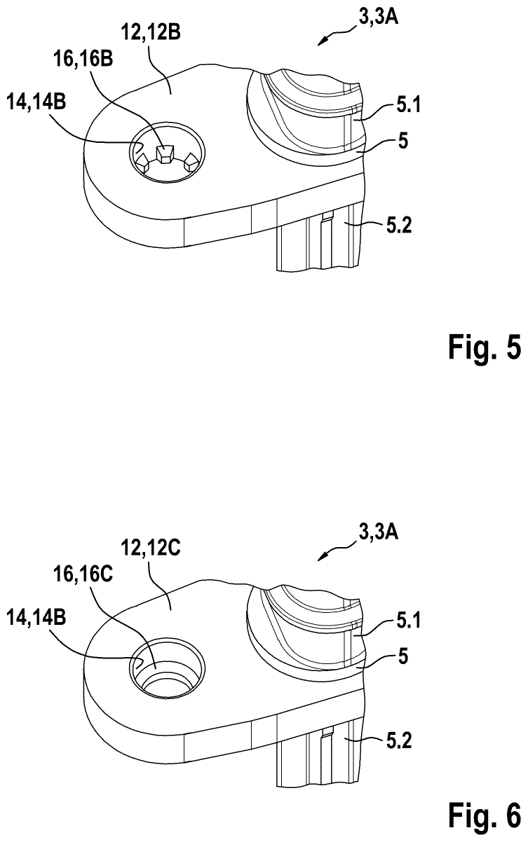

As can be further seen from FIGS. 5 and 6, the through-opening 14 in the illustrated exemplary embodiments of the plastic flange 12B, 12C is formed as a rotationally symmetrical opening 14B in the plastic flange 12B, 12C.

As can be further seen from FIG. 5, the constriction 16B in the illustrated second exemplary embodiment of the plastic flange 12B comprises a plurality of constriction segments 16B, which are formed at a distance from one another and evenly distributed on the inner circumference of the through-opening 14 designed as a rotationally symmetrical opening 14B.

In an exemplary embodiment of the plastic flange 12, which is not shown, these constriction segments 16B are evenly distributed at a distance from one another on the inner circumference of the through-opening 14, which is designed as an elongated hole 14A.

As can be further seen from FIG. 6, the constriction 16C in the illustrated third exemplary embodiment of the plastic flange 12C comprises a constriction lip 16C, which is formed circumferentially on the inner circumference of the through-opening 14 designed as a rotationally symmetrical opening 14B.

In an exemplary embodiment of the plastic flange 12 not shown, this constriction lip 16C is formed circumferentially on the inner circumference of the through-opening 14 designed as an elongated hole 14A.

1. An attachment arrangement, comprising;
a plastic flange which is connected to a component to be attached and has a through-opening; and
an attachment screw, the threaded shank of which is configured to pass through the through-opening of the plastic flange and be screwed into a threaded hole at an installation location,
wherein
an elastic constriction is formed in a region of the through opening, an inner spacing of which constriction is smaller than an outer diameter of the threaded shank of the attachment screw,
the threaded shank is configured to plastically and elastically deform an elastic material of the elastic constriction during the screwing-in process, such that, when the attachment screw is screwed in, a frictional connection is formed between threads of the threaded shank and a remaining elastic material of the elastic constriction, which frictional connection acts to prevent the attachment screw from loosening.

2. The attachment arrangement according to claim 1, wherein the elastic constriction is formed in an end region of the through-opening so as to face the threaded hole during the screwing-in process.

3. The attachment arrangement according to claim 1, wherein the through-opening is formed as an elongated hole in the plastic flange.

4. The attachment arrangement according to claim 3, wherein the elastic constriction comprises at least two constriction webs, which are formed on opposite longitudinal sides of the elongated hole.

5. The attachment arrangement according to claim 1, wherein the through-opening is formed as a rotationally symmetrical opening in the plastic flange.

6. The attachment arrangement according to claim 2, wherein the elastic constriction comprises a plurality of constriction segments which are designed to be distributed at a distance from one another on an inner circumference of the through-opening.

7. The attachment arrangement according to claim 2, wherein the elastic constriction comprises a constriction lip which is formed circumferentially on an inner circumference of the through-opening.

8. The attachment arrangement according to claim 1, wherein the plastic flange with the through-opening and the elastic constriction is designed as a plastic injection-molding component.

9. A sensor arrangement with a sensor, which is attached to the installation location via an attachment arrangement, wherein the attachment arrangement is designed according to claim 1.

10. The sensor arrangement according to claim 9, wherein:
the sensor comprises a housing having a first housing part and a second housing part, which is inserted into a slot at the installation location; and
the plastic flange between the first housing part and the second housing part is connected to the housing and is screwed to the threaded hole at the installation location via an attachment screw.
